(19) United States
(12) Patent Application Publication
(10) Pub. No.: US 2009/0314413 A1
(43) Pub. Date: Dec. 24, 2009

(54) APPARATUS AND METHOD FOR APPLYING TAX STAMPS

(75) Inventors: Jason L. Brandow, Fort Worth, TX (US); Marc J. Wilson, Byron Center, MI (US); Bruce D. DeBoer, Jenison, MI (US); James S. Rabourn, Caledonia, MI (US); Steven J. Lilly, Wyoming, MI (US); Jack E. Spaans, Sparta, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: R.E.D. STAMP, INC., Byron Center, MI (US)

(21) Appl. No.: 12/490,085

(22) Filed: Jun. 23, 2009

Related U.S. Application Data
(63) Continuation-in-part of application No. 12/329,888, filed on Dec. 8, 2008.
(60) Provisional application No. 61/012,254, filed on Dec. 7, 2007.

(51) Int. Cl. B32B 38/14; B32B 37/00

(52) U.S. Cl. 156/64; 156/349; 156/388; 156/378; 156/352; 156/277

(57) ABSTRACT

A tax stamp apparatus applies labels to individual packages of cigarettes, and prints tax information on the labels after they are applied to cartons of cigarettes. The apparatus may include a digital scanner that scans and decodes two-dimensional bar code information printed on the labels. The tax information may be supplied to the apparatus from a remote location, and the scanned data may be compared to the tax information supplied to the apparatus to verify that the tax indicia have been applied to the cartons of cigarettes.

### CROSS REFERENCE TO RELATED APPLICATION

This application is a continuation-in-part of U.S. patent application Ser. No. 12/329,888 filed on Dec. 8, 2008, entitled APPARATUS AND METHOD FOR APPLYING TAX STAMPS. U.S. patent application Ser. No. 12/329,888 claims the benefit of U.S. Provisional Application No. 61/012,254, filed on Dec. 7, 2007. The entire contents of each of the above-identified applications are incorporated by reference.

### BACKGROUND OF THE INVENTION

Various devices have been developed for applying tax information to cartons of cigarettes. Tax information is typically provided in the form of preprinted stamps that are applied to individual packages of cigarettes. Such stamps are often specific to a given date and/or local region. The stamps are typically applied prior to shipment of the cigarettes to the retailer such as a gas station or the like. Also, a given retailer may order a variety of different brands and sizes of cigarettes for a particular shipment.

### SUMMARY OF THE INVENTION

One aspect of the present invention is an apparatus for applying tax stamps to packages of cigarettes. The apparatus may include a support structure and a controller that is adapted to be operably connected to a network (e.g. the internet or other communication systems such as phone systems, satellite communication systems, etc.) to receive tax stamp data from a remote location utilizing the network. A conveyor system is mounted to the support structure for moving cartons of cigarettes along a path defining a downstream direction. A loading system receives cartons of cigarettes to be moved along the conveyor system, and an opening station downstream of the loading station opens cartons of cigarettes moving along the conveyor system. The apparatus may include a device that applies a recordable medium to the packages of cigarettes, such as a label applicator that adhesively applies labels to packages of cigarettes. The labels may be blank (i.e. without tax stamp information) at the time they are applied to the individual packages of cigarettes. The apparatus further includes a data-application station wherein tax stamp information or data is applied to individual packages of cigarettes. The data-application station may comprise a printer mounted to the support structure downstream of the label-applying station. The printer may be operably connected to the controller, and utilize tax stamp data to print tax stamps that may be in the form of two-dimensional (“2D”) bar codes or data matrix codes on the labels that were applied to the cartons of cigarettes at the label-applying station. The apparatus further includes a device that reads or captures the tax stamp data previously applied to the cartons. The device may comprise an optical scanner mounted to the support structure downstream of the data application station that reads the 2D bar codes printed on labels of packages of cigarettes by the printer, and generates data corresponding to the 2D bar codes. The controller compares the tax stamp data read by the optical scanner to the tax stamp data received by the controller from a remote location. The controller may thereby determine if the data from the optical scanner is the same (equivalent) to the supplied data to verify application of the data.

Another aspect of the present invention is an apparatus for applying tax stamps to packages of cigarettes including a conveyor system that moves cartons of cigarettes along a path defining a downstream direction. The apparatus includes a loading station configured to receive cartons of cigarettes to be moved along the conveyor system. The apparatus may include a label-applying station downstream of the loading station having an applicator that removes labels from a carrier strip and adhesively applies the labels to packages of cigarettes. The apparatus further includes a data-application station downstream of the label-applying station. The data-application station may include a printer that prints information on the labels that have been applied to the packages of cigarettes at the label-applying station. An optical device downstream of the printing station generates data corresponding to the information printed on the labels.

Yet another aspect of the present invention is a method of applying information to objects, and verifying the information. The method may include applying information in the form of tax stamps to packages of cigarettes. The method includes generating tax information, and supplying the tax information to an apparatus configured to apply the tax information to packages of cigarettes. The method further includes moving packages of cigarettes through the apparatus along a conveyor, and applying labels to packages of cigarettes. The method also includes printing tax information on the labels after the labels have been applied to packages of cigarettes. After the tax information has been printed on the labels, the tax information is scanned, and the scanned tax information may be compared to the tax information supplied to the apparatus to verify that the tax information has been applied to the packages of cigarettes.

### BRIEF DESCRIPTION OF THE FIGURES

FIG. 1 is an isometric view of a tax stamp apparatus according to one aspect of the present invention;

FIG. 2 is an isometric view of a portion of the tax stamp apparatus of FIG. 1;

FIG. 3 is a partially fragmentary isometric view of a portion of the tax stamp apparatus of FIGS. 1 and 2;

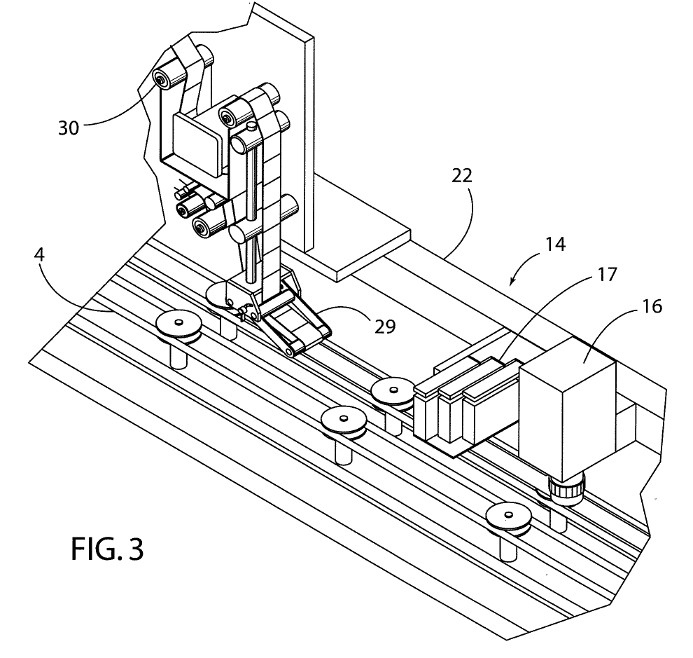

FIG. 4 is an isometric view of a portion of the tax stamp apparatus of FIG. 1;

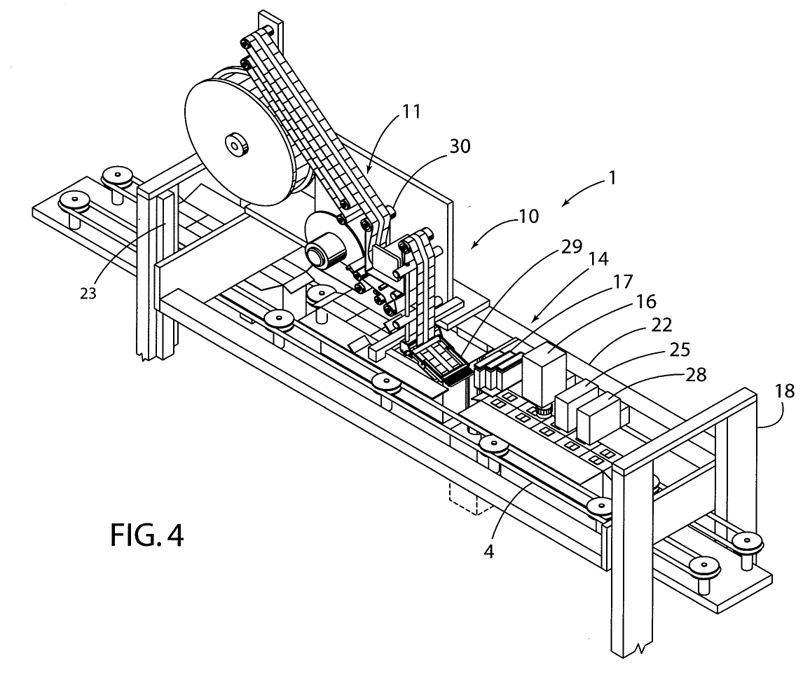

FIG. 5 is a partially fragmentary isometric view showing cartons of cigarettes in the apparatus of FIG. 1;

FIG. 6 is a side elevational view of a portion of the apparatus of FIG. 1;

FIG. 7 is a diagram showing a system for generating, distributing, and applying tax stamp information;

FIG. 8 is an isometric view of a tax stamp apparatus according to another aspect of the present invention;

FIG. 9 is a side elevational view of a portion of the apparatus of FIG. 8;

FIG. 10 is a cross-sectional view taken along the line X-X; FIG. 9;

FIG. 11 is a fragmentary view of a portion of the tax stamp apparatus taken along the line XI-XI; FIG. 9; and

FIG. 12 is a block diagram of the tax stamp apparatus of FIG. 8.

### DETAILED DESCRIPTION OF PREFERRED EMBODIMENTS

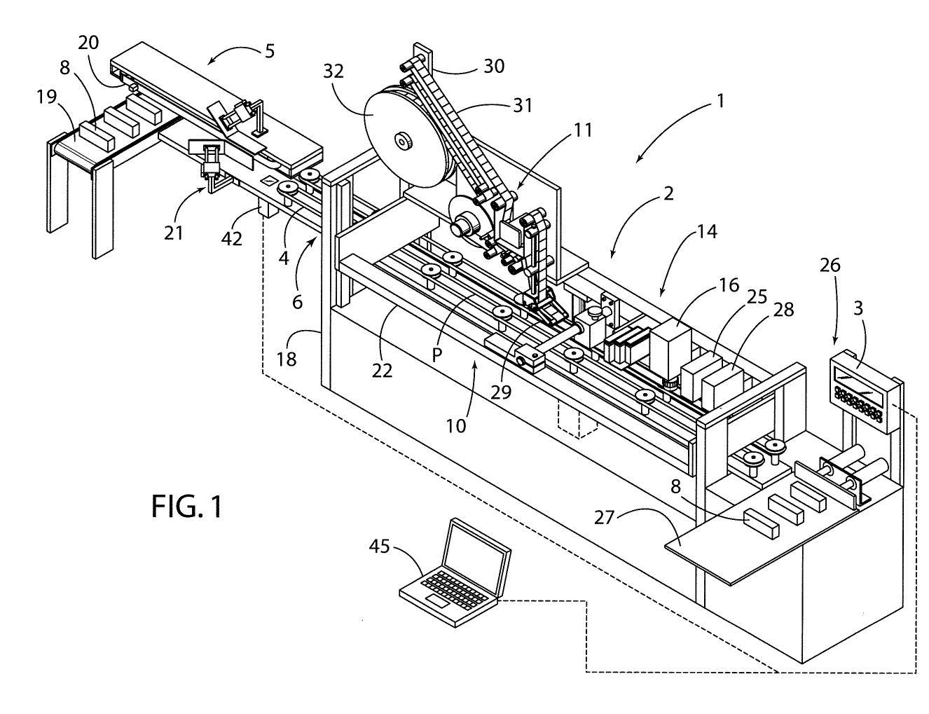

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

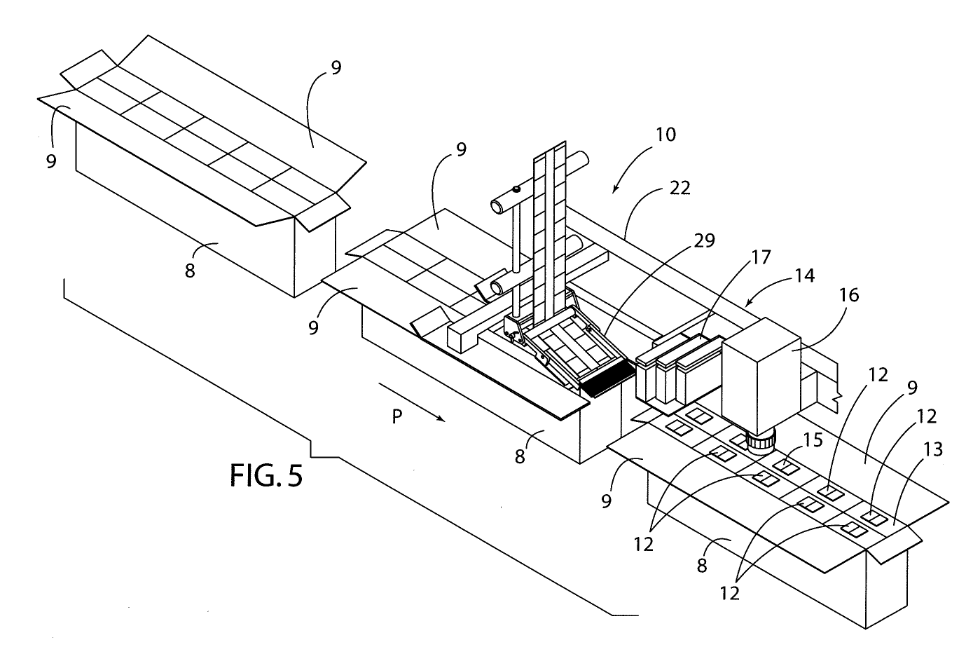

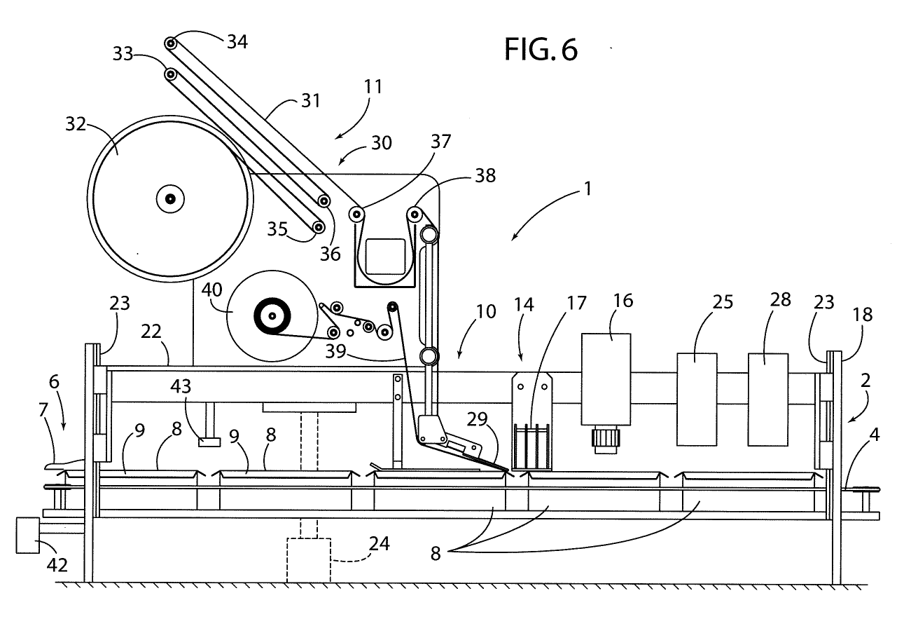

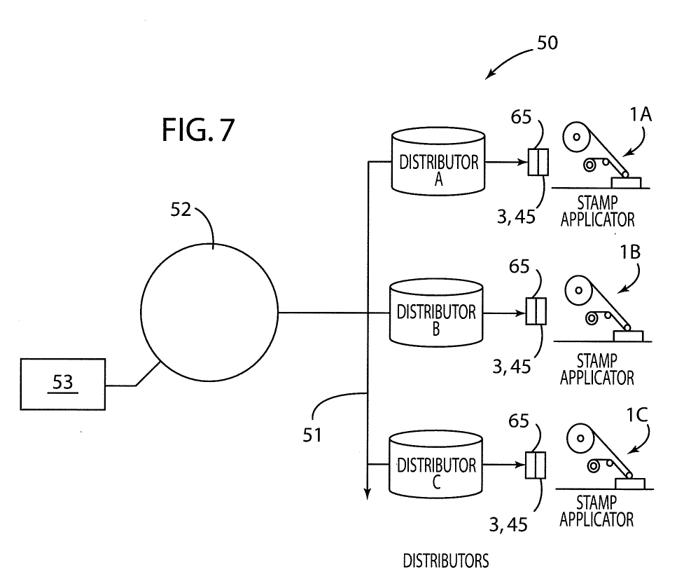

With reference to FIG. 1, a device or apparatus 1 for applying information such as tax stamp information to packages of cigarettes 8 includes a support structure 2 and a controller 3. As discussed in more detail below in connection with FIG. 7, the controller 3 may be connected to a network to receive tax stamp data from a remote location in digital form. The apparatus 1 includes a conveyor system 4 mounted to the support structure 2 for moving the cartons of cigarettes 8 along a path “P” (see also FIG. 5) defining a downstream direction. A loading station or system 5 receives cigarette cartons 8 that are moved along the conveyor system 4. An opening station 6 includes a “shoe” 7 (FIG. 6) that opens flaps 9 (FIG. 5) of cartons of cigarettes 8 moving along the conveyor system 4. As discussed in more detail below, apparatus 1 may include a scanner 42 positioned immediately upstream of opening shoe 7. Scanner 42 may be utilized to scan UPC bar code information printed on the cartons of cigarettes 8 by the manufacturers of the cigarettes.

Apparatus 1 may include a label-applying station 10 downstream of the opening station 6 that includes an applicator 11 that applies labels 12 (see also FIG. 5) to the individual packs or packages of cigarettes 13 in the cartons of cigarettes 8. The apparatus 1 also includes a data-applying device such as a printer 17 of printing station 14. Printer 17 may be mounted to the support structure 2 downstream of the label-applying station 10. The printing station 14 is operably connected to the controller 3, and utilizes tax stamp data to print tax stamps 15 (FIG. 5) that may be in the form of 2D bar codes or other suitable format on the labels 12 on the individual packages or “packs” of cigarettes 13. A data-reading or scanning device or station may include an optical scanner 16 that is mounted to the support structure 2 downstream of the printing station 14. The optical scanner 16 reads/scans the tax stamps 15 printed on the labels 12 (FIG. 5) by the printing station 14, and generates data corresponding to the tax stamps 15. The controller 3 compares the data from the optical scanner 16 to the digital tax stamp data supplied to the apparatus 1 to determine if the data from the optical scanner 16 is the same or equivalent to the digital tax stamp data from the optical scanner 16 to thereby verify that the data has been applied. As described in more detail below, in addition to controller 3, the control system of apparatus 1 may include a computer 45 that is operably connected to the internet or other communication systems to receive tax stamp data from a remote source. Also, computer 45 may be operably connected to controller 3 to provide data to controller 3, and controller 45 may also be operably connected to other components of the apparatus 1. For example, computer 45 may be operably connected to printer 17, and provide tax stamp data to printer 17. Also, various devices or components of apparatus 1 such as the printer 17, optical scanner 16, and other components may have some processing capability, and therefore may comprise part of the control system of apparatus 1. Apparatus 1 may also include a glue-applying device 25 that applies adhesive/glue to the flaps of cartons 8, and a device 28 that closes the flaps of cartons 8 after glue is applied to the flaps. Gluing device 25 and closing device 28 are operably connected to controller 3. Gluing device 25 and closing device 28 together form a closing station that may be substantially similar to known closing stations. One example of a closing station is described in U.S. Pat. No. 6,878,222, the entire contents of which are incorporated by reference.

As described in more detail below, the tax stamp data (e.g. bar codes) may be in an encrypted format, and the data scanned by optical scanner 16 is decrypted by controller 3 utilizing a “key”. An example of a suitable encryption system is disclosed in U.S. Pat. No. 6,681,214. If the scanned/decrypted data is not verified (e.g. it does not match the tax stamp data received by computer 45 over communication system/network 51 (FIG. 7), controller 3 will not cause glue applying device 25 to apply glue and/or stop loading station 5, conveyor system 4 and/or generate a signal to the operator to thereby alert the operator to the problem. The operator may be directed to go to the outfeed conveyor 27/unloading station 26 to inspect the unglued carton to determine why it was not verified. The operator can then determine the cause of the problem, make corrections, and resume operations.

Referring again to FIG. 1, the loading station 5 of the apparatus 1 may be substantially similar to the loading station described in issued U.S. Pat. No. 7,437,860, entitled STAMP APPLICATOR WITH AUTOMATIC SIZING FEATURE, issued on Oct. 21, 2008, the entire contents of which are hereby incorporated by reference. As described in more detail in this patent, loading station 5 may include an infeed conveyor 19, a belt 20, and a measuring station 21 that determines the height and/or width of the cartons of cigarettes 8.

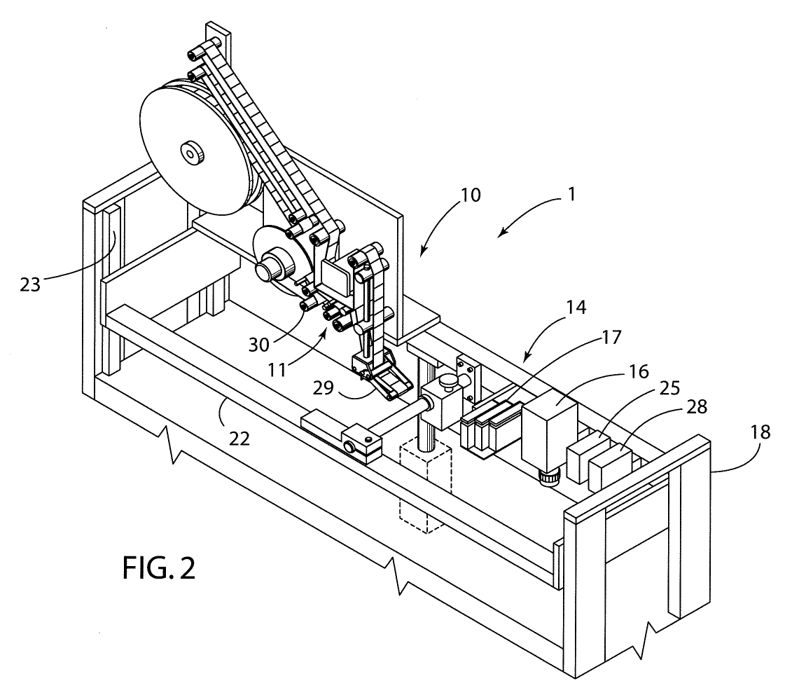

In the illustrated example, support structure 2 includes a primary support structure 18 and a moveable secondary support structure 22 (see also FIG. 6) that is moveably connected to the primary support structure 18 by linear guides 23 (FIG. 2). The size information concerning the cartons of cigarettes 8 may be utilized by the controller 3 to selectively actuate a powered actuator 24 (FIG. 6) to thereby shift the moveable secondary support structure 22 vertically relative to the primary support structure 18 to accommodate cartons of cigarettes 8 having different height dimensions. The shoe 7 (FIG. 6) of opening station 6, applicator 11 of label-applying station 10, printer 17 of printing station 14, optical scanner 16, gluing device 25, and closing device 28 may be mounted to the moveable secondary support structure 22, such that these components shift vertically upon actuation of powered actuator 24 to automatically accommodate cartons of cigarettes 8 having different heights. Apparatus 1 may also include an unloading station 26 having an outfeed conveyor 27 that is substantially similar to the unloading station described in more detail in U.S. Pat. No. 7,437,860. Also, conveyor system 4 may be adjustable to automatically accommodate for cartons of cigarettes 8 having different widths in substantially the same manner as described in more detail in U.S. Pat. No. 7,437,860.

Apparatus 1 may include a sensor 43 (FIG. 6) that measures the length of the cartons of cigarettes 8 as the cartons are moving between the opening station 6 and the peel tip 29. This enables the controller 3 to determine the position for each label 12, and the controller 3 can thereby actuate the printer 17 and the scanner 16 when the labels 12 are present for printing and scanning, respectively. In the illustrated example, sensor 43 comprises an emitter/detector positioned above the cartons 8, and a reflector positioned below the cartons 8. If the detector does not detect a reflected signal, this indicates a carton 8 is present. The shaft of the electric motor that powers the conveyor system 4 includes an encoder that provides controller 3 with position and/or velocity data that can be utilized to determine the velocity of cartons 8 as they move along conveyor system 4. This data and the data from sensor 43 can be utilized to determine the length of individual cartons 8.

Applicator 11 of label-applying station 10 includes a tape feed and a control device 30 (see also FIG. 6) of a known prior art design that feeds an elongated strip 31 from a roll 32 to the applicator 11. In the illustrated example, tape feed and control device 30 is a commercially available unit made by Label-Aire, Inc. of Fullerton, Calif. The tape feed and control device 30 includes a plurality of rollers 33-38 (FIG. 6) that facilitate feeding elongated strip 31 at the required feed rates. The elongated strip 31 (FIG. 6) generally includes a carrier strip comprising an elongated strip 39 of backing material having a non-stick first surface, with a plurality of labels 12 having adhesive on one side thereof disposed on the non-stick surface. The labels 12 may be blank as supplied on roll 32 (FIG. 6). Such labels are commercially available in rolls 32. The labels 12 may have various security features to prevent tampering, forging, etc. For example, the labels 12 may have a pre-printed logo or other identifying features such as micro printing, light-reactive ink, special features to provide a unique tactile feel, etc. Such features may be similar to security (anti-counterfeiting) features of money or postage stamps. Applicator 11 also includes a “peel tip” 29 that receives strip 31 from tape feed and control device 30 and pairs of labels 12 from the non-stick strip 39 of material and adhesively applies the labels 12 to the packages of cigarettes 13. After the labels 12 (FIG. 5) are applied to the packages of cigarettes 13, a remaining strip 39 (FIG. 6) of backing material is wound onto a roll 40 for collection and eventual disposal. The peel tip 29 of applicator 11 may also be of a known design, such that the details of the peel tip 29 will not be further described in detail herein.

In the illustrated example, the printer 17 is located downstream of the label-applying station 10. However, printer 17 may be configured to print tax indicia on the labels 12 before the labels 12 are applied to the packages of cigarettes (e.g. while the labels 12 are still on roll 32). Printer 17 may also be configured to print tax stamp indicia (e.g. bar codes) on labels 12 as the labels 12 feed through peel tip 29, either just before the labels 12 are applied, as the labels 12 are applied, or just after labels 12 are applied.

In contrast to heat transfer type stamping units, the tape feed and control device 30 can be configured to apply the labels 12 without slowing down or stopping the cartons of cigarettes 8 as the labels 12 are applied. Because the tape feed and control device 30 can be configured to apply the labels 12 without stopping the cartons 8, a greater number of cartons 8 can be processed by apparatus 1 in a given period of time.

According to another aspect of the present application, the individual packages of cigarettes 13 may be packaged such that the printer 17 prints the tax information directly onto the packages of cigarettes 13. In this case, apparatus 1 may be configured such that it does not include a label-applying station 10.

In the illustrating example, the printer 17 (FIG. 16) comprises a commercially available Hewlett-Packard cartridge system that is operably connected to the controller 3. However, it is readily apparent that a wide variety of printers could be utilized. Printer 17 may be configured to print tax indicia utilizing invisible ink or ink that is chemically marked for security purposes. Also, printer 17 may include ink that is applied to labels 12, or it may comprise a laser or other device that burns the tax indicia onto labels 12 or directly onto the packages of cigarettes. In the illustrating example, the optical scanner 16 comprises an unattended scanning system having a decoding unit that decodes the 2D bar codes forming tax stamps 15 printed on the individual labels 12 (FIG. 5). In a preferred embodiment, the optical scanner 16 comprises a commercially available scanner available from Cognex Corporation of Natick, Mass. However, it will be apparent that other scanners/cameras may also be utilized. If printer 17 utilizes invisible ink or other light-reactive ink, ultra violet or other suitable lights producing light having the necessary frequency may be utilized at optical scanner 16 to ensure the ink is visible for scanning purposes. Scanner 16 may be selected to provide the required scanning capability with respect to a specific ink being utilized for a given application.

As discussed above, apparatus 1 may print the bar code information on the blank labels 12 after the labels are applied to the individual packs of cigarettes. Alternately, the tax stamp information may be printed on the blank labels 12 by apparatus 1 immediately prior to applying the labels to the individual packs of cigarettes. Still further, 2D bar codes or other encrypted tax stamp information may be pre-applied to the labels 12 to form a roll 32 (FIG. 1) of pre-printed tax stamps. A roll 32 of pre-printed to labels 12 with a 2D bar code or other encrypted tax code information can then be loaded into tape feed and control device 30, and the pre-printed labels 12 are then applied to the individual packs of cigarettes. The optical scanner 16 can then be utilized to scan the data, and the data can be decrypted utilizing a key as described above. If pre-printed labels/tax stamps are utilized, the tax stamp information is not distributed electronically to individual tax stamp applicators (FIG. 7) via a communication system/network 51. However, the scanned and decrypted information concerning the tax stamps can be processed and/or distributed over communication system/network 51 by controller 3 and/or computer 45.

In the illustrated example, tax stamps or tax information/indicia 15 are in a form commonly referred to as a “2D bar code.” This information is preferably in an encrypted form to provide for increased security, and the 2D bar code may be printed on labels 12. It will be understood that tax information applied to the packages of cigarettes may be in other forms such as other printed images, electromagnetic data, chemical markers, or other optical storage mediums and methods. For example, the label-applying station 10 could apply a magnetic strip or RFID tag to the individual packages of cigarettes 13. If a magnetic strip is utilized, the data-applying device could comprise a device that writes/records the tax stamp information on the magnetic strip, and the data-reading or scanning device could comprise a magnetic reader that would read the data from the magnetic strip.

If, for example, an RFID tag is utilized, the information may be in a serialized form rather than being encrypted. In general, serialized information includes a number or other information that is applied to form a tax stamp. After the number or other information/indicia on a particular pack of cigarettes is scanned, a table is then utilized to determine what tax stamp information has been assigned to the number or other indicia. Thus, serialization type systems/technologies typically utilize a table or the like to determine what information has been assigned to a particular number or indicia. In contrast, if the tax stamp is applied in an encrypted format, the tax stamp information is present on the packages of cigarettes, and the key is utilized to decrypt the information into a useable form. Thus, encryption systems generally do not require use of a table or the like to determine what tax stamp information has been assigned to a particular number or other indicia. It will be understood that the apparatus and method of the present invention may be utilized to apply indicia/information other than tax stamp information to a variety of products, parts, components, and the like, other than packages of cigarettes.

With further reference to FIG. 7, a plurality of individual stamp applicator devices 1A-1C (or more) may be operably connected to form a tax stamp generation, distribution, and verification system 50. In the illustrating example, the system 50 may be operably connected to distributors A-C, each having a stamp applicator 1A-1C, respectively, that may be substantially similar to the apparatus 1 described in more detail above. The distributors A-C are connected to a system 52 via network or communication system 51. In the illustrated example, each distributor has a single stamp applicator device. However, each distributor could have two or more stamp applicators 1 connected to communications system 51. The network or communication system 51 may comprise the internet and/or other communication systems such as telephone systems, wireless communication systems such as cell phone systems or satellite communication systems, fiber optic or electrical communication systems, or the like. System 52 generates digital tax stamp information upon receipt of an order from one or more of the distributors A-C, and supplies the data to network 51. Preferably, the controllers 3 of each applicator 1A-1C include a firewall 65 to prevent unauthorized access to the controllers 3. In the illustrated example, system 52 comprises a commercially available product authentication system available from Authentix Corporation of Addison, Tex. System 52 may comprise a system and method according to U.S. Pat. No. 6,681,214, issued on Jan. 20, 2004, the entire contents of which are incorporated by reference. However, system 52 may also comprise other commercially available systems that generate digital tax stamp data, and distribute the data over a network or other communication system.

In use, distributors A, B, or C, place orders with a government tax agency 53 or other tax authority, and the system 52 provides tax stamp data in digital format to the distributor via network 51. The individual distributors A-C then print the digital tax stamp indicia on the packages of cigarettes utilizing the stamp applicators 1A-1C, and the cartons of cigarettes 8 are then shipped to retail outlets. Although the tax stamp data is preferably in an encrypted digital format, analog tax stamp data could also be generated and distributed over network/communication system 51, and applied to the blank labels/stamps 12. An analog printer and scanner may be used instead of digital printer 17 and digital optical scanner 16.

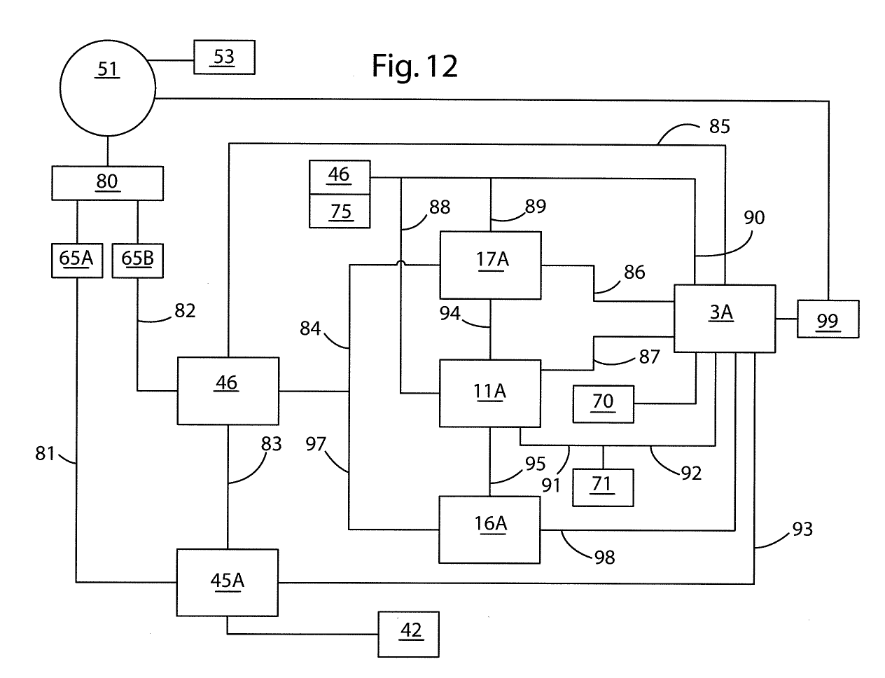

As discussed in more detail below in connection with FIG. 12, the scanner 42 (FIG. 6) may be operably connected to controller 3 and/or computer 45 and communication systems or network 51. Scanner 42 may operate in conjunction with a commercially available cigarette tax verification system that is available from Tax-Right, LLC of Hammonton, N.J. An example of such a verification system is described in U.S. Pat. No. 6,704,614. The scanner 42 may be configured to scan UPC bar code information printed on the cartons of cigarettes 8 by the manufacturer, and this information can be provided to the controller 3 and/or computer 45. The UPC information may include the brand of cigarettes, type of cigarettes, and other such information.

In use, an order concerning cigarettes to be stamped may be supplied to the controller 3 and/or computer 45. The order may include information concerning the number of each brand and type of cigarettes, and encrypted tax stamp information. The information from the UPC code that is scanned by scanner 42 can be compared to the information for a particular order. If the information from scanner 42 does not correspond to an order (e.g. the UPC information from scanner 42 is for a brand and/or type of cigarettes that is not present in the order), controller 3 generates a signal to stop the infeed conveyor 19, conveyor system 4, and/or other components. Similarly, if the UPC code information is unreadable by scanner 42, controller 3 may stop the conveyor system 4 and/or infeed conveyor 19 and/or other components. Still further, controller 3 may be configured to prevent operation if an operator attempts to begin work on an order prior to completion of a prior order.

Also, the UPC information concerning the brand and/or type of cigarettes generated by scanner 42 can be utilized to determine if the number and/or type of cigarettes sold in a given jurisdiction comply with the Master Settlement Agreement (“MSA”). In general, under the MSA cigarette companies provide estimates to local jurisdictions concerning the number of cigarettes sold within the particular jurisdiction, and the payments under the MSA are based on this estimate. According to another aspect of the present invention, the UPC/brand information for the cigarettes from scanner 42 can be utilized in conjunction with the tax stamp information for a specific jurisdiction to provide a report to the local government (e.g. state government) concerning the number of cigarettes stamped for a particular jurisdiction. This information can be compared to the estimates provided by the cigarette manufacturers to ensure that the payments under the MSA are accurate. Because the tax stamp information includes information concerning the jurisdiction (e.g. state) within which particular cigarettes will be sold, the combination of the tax stamp information and the UPC information from scanner 42 can be utilized to determine the number or cigarettes of a particular brand that are sold in a specific jurisdiction.

Referring again to FIG. 7, the tax stamp applicators 1A, 1B, 1C, etc. may be operably connected to a government tax agency 53 or other tax authority. The stamp applicators 1A, 1B, 1C, etc. may be operably connected to the government tax agency 53 such that the government agency 53 has at least some control over the operation of the individual stamp applicators 1A, 1B, 1C, etc. For example, if the government tax agency 53 determines that the UPC information from scanner 42 is not MSA compliant, the government tax agency 53 can shut down one or all of the applicators 1A, 1B, 1C, etc. Furthermore, if the government tax agency 53 determines that the tax stamp information applied by the apparatus 1 and scanned by optical scanner 16 does not comply with the requirements of the government tax agency 53, the government tax agency 53 can shut down the apparatus 1 and/or generate a signal to the operator utilizing controller 3 and/or computer 45.

The government tax agency 53 may also control the stamp applicators 1A, 1B, 1C, etc. utilizing approved manufacturers and/or brands criteria. For example, if only certain manufacturers are approved in a particular state, the UPC brand information printed on the cartons and scanned by scanner 42 may be compared to the approved list of manufacturers by the government tax agency 53. If a particular carton 8 of cigarettes entering apparatus 1 is not on the approved list, the government tax agency 53 can stop apparatus 1 and/or generate a signal to the operator or other entity.

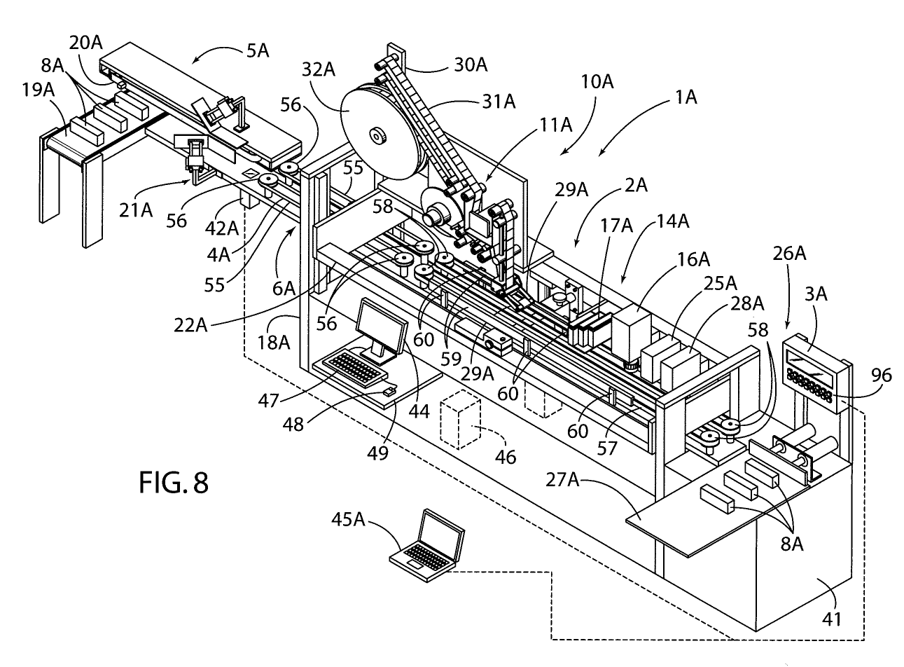

A tax stamp apparatus 1A according to another aspect of the present invention is shown in FIGS. 8-11. The apparatus 1A includes many of the same components as the apparatus 1, and the components that are common to the apparatus 1 and the apparatus 1A are designated utilizing same part numbers, except that the letter “A” has been added to the part numbers in FIGS. 8-10. In addition to controller 3A and computer 45A, apparatus 1A includes a second controller 46 that is operably connected to controller 3A and computer 45A. Controller such as a CPU/computer 46 is mounted within enclosure 41 of primary support structure 18A. A keyboard 47, mouse 48 and display screen 44 are operably connected to controller 46. Keyboard 47 and mouse 48 may be positioned on a pull-out tray 49. Display screen 44 may also be positioned on tray 49. As described in more detail below in connection with FIG. 12, controllers 3A and 46, and computer 45A together control operation of apparatus 1A. It will be understood that apparatus 1 (FIG. 1) may include a control system that is substantially similar to the arrangement of FIG. 12. Apparatus 1A includes a conveyor system 4A (FIG. 8) including looped belts 55 that are supported and driven by a plurality of pulleys 56. The belts 55 have a circular cross-sectional shape that is substantially the same as the belt forming the conveyor system 4 of the apparatus 1. Conveyor system 4A of apparatus 1A also includes timing belts 57 that are driven and/or supported by a plurality of timing pulleys 58.

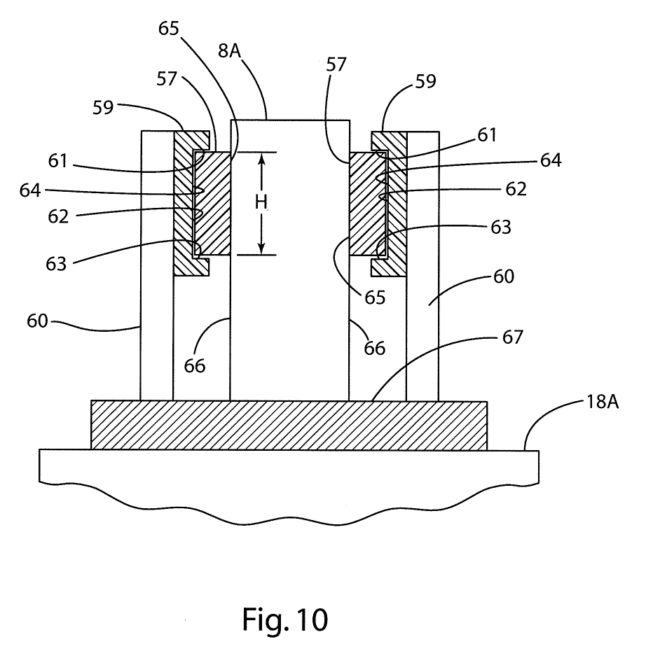

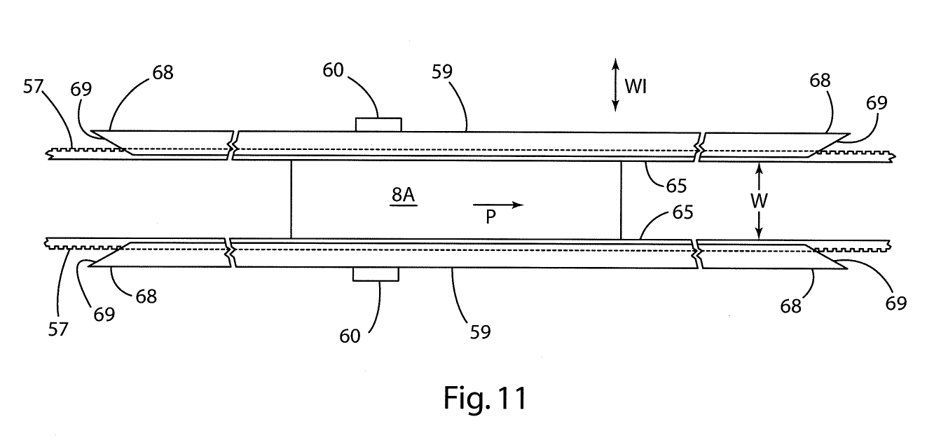

A pair of elongated guide members 59 are mounted to primary support structure 18A by a plurality of upright support members 60. The timing belts 57 have a generally rectangular cross sectional shape with a height “H” (FIG. 10) of about 25 mm in the illustrated example. Timing belts 57 may comprise urethane steel cord timing belts with a “Green Super Grip Cover”, Part No. 25-T10-4070TW, available from BRECOflex Co., L.L.C. of Eatontown N.J. Timing belts 57 include a plurality of teeth that engage teeth of pulleys 58 such that belts 57 do not slip on pulleys 58, and the position of belts 57 relative to pulleys 58 does not change. Elongated guide members 59 include U-shaped elongated channels 64 defined by side surfaces 61 and 63 and base surface 62. The guide members 59 are made of a low-friction material such as nylon or the like. With reference to FIG. 11, the ends 68 of guide members 59 may include angled surfaces 69 that guide the belts 57 into the channels 64. Controller 3A may cause one or both of the guide members 59 to be moved in the direction of the arrow “W1” to adjust the spacing “W” between belt surfaces 65 to accommodate cartons 8A of different sizes in response to information received from measuring station 21A. The elongated channel 64 supports and guides the timing belts 57 such that the inner surfaces 65 of timing belts 57 contact outer side surfaces 66 of carton 8A. The cartons 8A are supported on a guide surface 67 that is secured to the primary support structure 18A. The guide surface 67 may be substantially similar to support surfaces utilized in prior art machines for applying tax stamps to cartons of cigarettes.

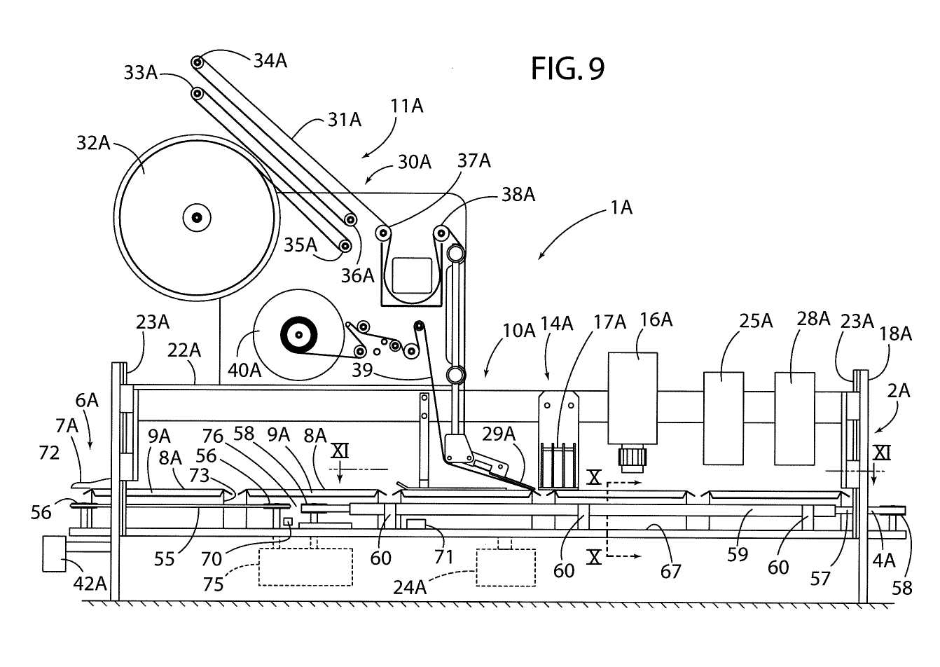

The relatively large, flat inner surfaces 65 of timing belts 57 support and stabilize the cartons 8A as they pass through the label-applying station 10A (FIG. 9), printing station 14A, and pass below the optical scanner 16. The surfaces 65 of belts 57 have a high coefficient of friction. Also, belts 57 are relatively thick and resilient, thereby providing a spring-like biasing effect that maintains contact between belt surface 65 and side surfaces 66 of cartons 8A. The high friction belt surfaces 65 and resiliency of belts 57 ensure that cartons 8A do not slip relative to belts 57 such that cartons 8A move at the same velocity as belts 57. Also, because the teeth of belts 57 engage the teeth of pulleys 58, the timing belts 57 do not slip relative to timing pulleys 58. Thus, the velocity and portion of cartons 8A can be accurately determined from the velocity and position of pulleys 58. The timing belts 57 are supported and guided by the elongated channels 64 in the guide members 59, such that the timing belts 57 are stable and thereby substantially prevent rotation or side-to-side motion of cartons 8A. Belts 57 preferably contact the side surfaces 66 of cartons 8A at least two vertically spaced-apart locations to resist rotation of cartons 8A about the axis of movement (e.g. arrow “P”, FIG. 5) of the cartons 8A. The support provided by the timing belts 57 thereby stabilizes the cartons 8A to permit accurate printing in the printing station 14A, and also facilitates scanning by optical scanner 16A. Although it is presently preferred that two belts 57 are utilized, with a flat side face 65 of each belt 57 contacting opposite side surfaces 66 of cartons 8A. However, four belts could be utilized, with a pair of vertically spaced-apart belts contacting side surfaces 66 of cartons 8A at vertically spaced-apart locations to prevent or resist rotation of cartons 8A about their axis of movement. Also, although the belts preferably contact both side surfaces 66 of cartons 8A, a low-friction sliding or rolling surface may be utilized to contact one side surface 66 of cartons 8A instead of one of the belts 57. Furthermore, a single timing belt (not shown) having a construction that is similar to belt 20A could be positioned below cartons 8A, with a horizontal upwardly-facing surface configured to engage the lower surfaces of cartons 8A. When a single belt is utilized in this way, a pair of support surfaces may be configured to engage the opposite side surfaces 66 of cartons 8A to prevent rotation of cartons 8A. The support surfaces could be adjustable relative to one another to accommodate cartons 8A of different widths. Also, the support surfaces may comprise low-friction surfaces that slidably engage opposite side surfaces 66 of cartons 8A, or the support surfaces could comprise movable rollers or belts that engage side surfaces 66 of cartons 8A.

Referring again to FIG. 9, apparatus 1A may include first and second sensors 70 and 71 that are operably connected to the controller 3A (FIG. 8). Sensor 70 is a “carton present” sensor that detects the leading and trailing edges of cartons 8A as they move past sensor 70. As discussed in more detail below in connection with FIG. 12, belts 55 may be stopped to retain/stop one or more cartons 8A between belts 55, while timing belts 57 may simultaneously be driven to move cartons 8A that are in contact with belts 57 out of the label-applying station 10A, printing station 14A, and past the optical scanner 16A. Sensor 70 enables controller 3A to stop belts 55 based on detecting a leading edge of a carton 8A that is still solely in contact with belts 55, and/or detecting a trailing edge of a carton 8A that is solely in contact with timing belts 57. Sensor 71 detects the presence of cartons 8A that are proximate sensor 71. A powered drive system 75 includes an electric motor (not shown) or other suitable powered actuator. Powered drive system 75 may include an encoder 46 (FIG. 12) or the like that provides controller 3A with position data which can be utilized to determine the velocity of belts 57. Because the position and/or velocity of the cartons 8A is known, the length of the cartons 8A can be determined by controller 3A. As discussed above, the resiliency of belts 57 and high friction surfaces 65 of belts 57 ensure that cartons 8A move at the same velocity as belts 57. This enables accurate calculation of the length of cartons 8A utilizing sensor 71.

Belts 55 and pulleys 56 may be driven by a powered drive system 75 that is also operably connected to the timing pulleys 58 to drive the timing belts 57. Powered drive system 75 includes an electric motor or other powered actuator that is operably connected to the controller 3A. Controller 3A controls the rotational rate of drive system 75, and also receives data from drive system 75 concerning the rotational rate of drive system 75 via encoder 46. The drive system 75 also includes a clutch (not shown) that can be selectively engaged or disengaged by controller 3A. When the clutch is engaged, the pulleys 56 and 58 are both driven at substantially the same rate, such that the belts 55 and the timing belts 57 move at substantially the same velocity. The individual cartons of cigarettes 8A are thereby first moved by belts 55, and the cartons 8A are moved across gap 76 between belts 55 and timing belts 57 during normal operation of apparatus 1A. Belts 57 then move the cartons 8A through the apparatus 1A to the out feed conveyor 27. However, if controller 3A determines that a tax stamp has not been properly printed (i.e. scanner 16A provides data to controller 3A indicating that a tax stamp did not correspond to the data provided to the printer 17A), the clutch may be disengaged such that belts 55 stop, while timing belts 57 continue to move. In this way, a “bad” carton 8A can be cleared from the system by timing belts 57 without feeding additional cartons 8A into the label-applying station 10A. The source of the problem can then be determined and normal operation with belts 55 and 57 moving simultaneously can be resumed once the problem is corrected.

With further reference to FIG. 12, controllers 45A and 46 are connected to firewalls 65A and 65B, respectively. The firewalls 65A and 65B correspond to the firewall 65 described above in connection with FIG. 7, and the controllers 45A and 46 correspond to the controller 45 of FIG. 7. The firewalls 65A and 65B are connected to an Ethernet switch 80, which is connected to a network 51 (e.g. the internet), and a remote tax authority 53 and/or other entities are operably connected to the network 51. Controller 45A may receive technical support, updates, or the like utilizing connection 81. Controller 45A may also receive order information that may be compared to information received by controller 45A from UPC bar code scanner 42. This information may be received from various entities that are operably connected to the network 51. Controller 46 may receive tax stamp data, verification data, production statistics, and administrative information and/or control signals or information from remote tax authority 53 and/or other entities via connection 82.

In operation, controller 45A receives scanned information concerning UPC bar codes from scanner 42, and provides the controller 46 with the scanned UPC data and/or order information received by controller 45A from remote tax authority 53. Controller 46 provides printer 17A with tax stamp/bar code data that is utilized by printer 17A to print the bar codes on the individual labels 12 (see also FIG. 5). A connection 85 provides a discrete interface between controller 3A and controller 46 whereby controller 3A provides a timing signal to controller 46 providing a trigger for controller 46 to send a predefined number of codes to the buffer of printer 17A. Printer 17A and label-applying machine 11A are also connected to controller 3A by discrete interface control connections 86 and 87, respectively. Connection 86 may be utilized to provide status information concerning printer 17A to machine control 3A. For example, information concerning whether or not printer 17A is turned on, has sufficient ink, and is otherwise ready to operate may be provided to controller 3A. Similarly, connection 87 may be utilized to provide information concerning the operational characteristics of label-applying machine 11A to machine controller 3A. For example, label-applying machine 11A may provide information concerning the number of labels 12 (see also FIG. 5) remaining on roll 32 to machine control 3A, and may also supply information concerning the operational readiness of label-applying machine 11A to machine controller 3A.

Encoder 46 is operably connected to drive system 75, and provides a pulse signal or train to label-applying machine 11A, printer 17A, and controller 3A via connections 88, 89, and 90, respectively. Sensor 71 provides information concerning the length of cartons 8A to label-applying machine 11A and controller 3A via connections 91 and 92, respectively. Label-applying machine 11A also receives pulse information from encoder 46. Label-applying machine 11A can calculate the length of a carton 8A utilizing the “carton present” signal from sensor 71 and pulse information from encoder 46. Label-applying machine 11A can provide this information to printer 17A via connection 94. Similarly, the carton size information can be provided to scanner 16A by label-applying machine 11A via connection 95. Thus, label-applying machine 11A determines where to position the labels on the individual cartons utilizing information from sensors 71 and encoder 46, and also supplies printer 17A and scanner 16A with information concerning the size of the cartons 8A and/or the positions of the labels on the cartons such that the printer 17A can print the information at the proper locations, and the scanner 16A can scan the proper locations to verify that the bar codes have been properly printed. For example, the controller of label-applying machine 11A may be programmed/configured to calculate a target location for the individual labels 12 (e.g. five sets of two labels) on the packages 13 (see also FIG. 5) of cigarettes. At the appropriate time, label-applying machine 11A sends a pulse train of five “triggers” (signals) to the printer 17A, causing printer 17A to print the bar codes on the labels 12. Label-applying machine 11A also sends a pulse train of five “triggers” to optical scanner 16A at the appropriate time as required to cause the optical scanner 16A to scan the bar codes on labels 12. Controller 3A is also connected to controller 45A by a discrete interface connection 93. Also, in operation, if controller 45A determines that a scanned UPC bar code from scanner 42 does not correspond to a UPC bar code received in an order, controller 45A can send a signal to controller 3A via connection 93. Controller 3A may then alter operation of the apparatus. For example, controller 3A may stop belts 55 (FIG. 8), while causing belts 57 to continue to move until cartons 8A that are in contact with belts 57 are cleared from the machine. Controller 3A may also cause glue applying apparatus 25 to halt application of glue as the cartons 8A that do not meet the UPC requirements are cleared from the apparatus.

In operation, the controller 46 receives the tax stamp data, and controller 45A may receive order information relating to UPC bar codes of a specific order. The presence of the tax stamp data and order information is provided to controller 3A via connections 85 and/or 93. Information concerning the status of the tax stamp data may be displayed to a user via display screen 44 of controller 46 and/or machine control 3A. In general, controllers 45A and 46 provide a user interface with remote tax authority 53 and other remote entities to provide for downloading of tax stamp data, order information, and the like, whereas machine controller 3A provides for user control of the apparatus once the tax stamp data, order information, and other information have been received by the apparatus from one or more remote sources. Once the tax stamp data, order information, and/or other information has been received by controllers 45A and 46, a user utilizes user interface 96 (FIG. 8) of machine controller 3A to control operation of the apparatus 1A. As discussed above, measuring station 21A measures the height and width of incoming cartons 8A. This information is provided to controller 3A to provide for control of the width of belts 55 and 57, and also to control the height of movable support structure 22. Control of the height of support structure 22 thereby controls the height of label-applying machine 11, printer 17, scanner 16A, glue-applying device 25A, and closing device 28A.

Machine controller 3A utilizes position and/or size data concerning the cartons 8A obtained from sensors 70 and/or 71 to provide a signal to the controller 46 causing controller 46 to send a group of bar code data sets to the buffer of printer 17A at the proper time. As discussed above, the label-applying machine 11A controls the timing of the label-applying machine 11A itself, as well as the timing of the printer 17A and scanner 16A. Label-applying machine 11A provides a print trigger signal to printer 17A causing printer 17A to print the bar code data received in its buffer from controller 46, and also sends a trigger to the scanner 16A to scan the bar code information printed on the labels by printer 17A. Scanner 16A generates a “go” or “no go” signal to machine controller 3A based on whether or not the bar code scanned by scanner 16A meets predefined criteria. It will be understood that the predefined criteria may vary depending upon the requirements of a particular application. In general, various quality criteria for the scanned data may be utilized, and the specific criteria utilized to generate a “go” or “no go” signal will vary depending upon requirements of a particular application. As discussed above, machine controller 3A may generate a signal causing belts 55 to stop, and also causing the glue-applying station 25 to stop applying glue if a “no go” signal is received from scanner 16A via connection 98.

The scanned and decoded bar code information from scanner 16A is also supplied to controller 46 by a connection 97. Controller 46 may supply the verification data to remote tax authority 53 and/or other entities via connection 82 and network 51. If the remote tax authority 53 determines that the verification data does not meet predefined criteria, the remote tax authority 53 may generate a signal to controller 46. Controller 46 may then provide a signal to the user via display screen 44 to the effect that the verification data did not meet predefined criteria. Also, the controller 46 may generate a signal to controller 3A causing the controller 3A to alter operation of apparatus 1A. For example, controller 3A may partially or completely shut down operation of apparatus 1A if remote tax authority 53 determines that the verification data did not meet the predefined criteria. Controller 3A may also stop operation of apparatus 1A if the remote tax authority determines that a particular user (distributor) is not properly licensed or is otherwise not authorized. This shut down may include stopping belts 55 and glue-applying station 25.

Controller 3A may be connected to the internet 51 via a modem 99 to provide for remote access to controller 3A. This provides for remote technical support for trouble shooting, monitoring of the operation of controller 3A/apparatus 1A, updating of software, and other such functions.

The tax stamp apparatus 1 (FIG. 1) and 1A (FIGS. 8-10) of the present invention provide a way to create a tax stamp at the time it is applied to the individual cartons of cigarettes. In this way, potential problems (e.g. physical security) associated with pre-printing tax stamps can be eliminated. Furthermore, the apparatus 1 provides verification that the digital tax stamp data has actually been printed on the individual packages of cigarettes utilizing the scanner. In this way, immediate verification that the tax stamps have been properly printed can be provided immediately and distributed by the network. Also, unique codes including a relatively large amount of data may be included on each stamp. For example, each stamp may include information concerning the distributor's identification, date and time of application of the stamp, brand and type of cigarettes, stamp value, and cigarette pack denomination. Also, the tax stamp information may be in an encoded or encrypted format to prevent unauthorized access to the data. If the tax stamp data applied in the bar code is encrypted. The system thereby improves improved security, and substantially eliminates the possibility of forging tax stamps, theft of tax stamps, or other such security problems.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. An apparatus for applying tax indicia to packages of cigarettes of the type having generally vertical opposite side faces, the apparatus comprising:
a support structure;
a control system configured to receive tax stamp data;
a powered conveyor system operably connected to the control system, wherein the conveyor system is mounted to the support structure for moving cartons of cigarettes along a path defining a downstream direction;
a loading system configured to receive cartons of cigarettes to be moved along the conveyor system;
an opening station downstream of the loading station, the opening station having an opening member shaped to open flaps of cartons of cigarettes moving along the conveyor system to provide access to packages of cigarettes in the cartons;
a label-applying station downstream of the opening station, the label-applying station including an applicator that applies labels to packages of cigarettes;
an information-applying station including a device configured to apply tax information to packages of cigarettes, wherein the tax information corresponds to the tax data; and wherein:
the conveyor system includes at least one elongated belt forming a loop with at least one substantially linear portion, the conveyor system further including at least one guide member supporting the linear portion of the elongated belt, wherein the substantially linear portion of the belt includes a substantially flat side face that contacts vertical side faces of packages of cigarettes as the packages of cigarettes move through the information-applying station.

2. The apparatus of claim 1, wherein:
the information-applying station comprises a printing station, and
the device comprises a printer.

3. The apparatus of claim 2, wherein:
the printing station is located downstream of the label-applying station.

4. The apparatus of claim 3, including:
an optical scanner mounted to the support structure downstream of the printing station, wherein the optical scanner reads the tax indicia printed on labels by the printing station and generates data corresponding to the tax indicia; and wherein:
the data generated by the optical scanner is evaluated according to predefined criteria to determine if the predefined criterion is satisfied.

5. The apparatus of claim 1, wherein:
the control system receives tax information from a remote source.

6. The apparatus of claim 1, wherein:
the control system is connected to a worldwide network of computers and receives the tax information from a remote source connected to the worldwide network.

7. The apparatus of claim 4, wherein:
the control system alters the operation of the apparatus if the data generated by the optical scanner does not satisfy the predefined criteria.

8. The apparatus of claim 7, wherein:
the control system stops movement of the one elongated belt if the data generated by the optical scanner does not satisfy predefined criteria.

9. The apparatus of claim 7, including:
a gluing station including a gluing device configured to apply glue to flaps of cartons of cigarettes after the flaps have been opened by the opening station;
a closing device configured to close flaps of cartons of cigarettes after the cartons pass through the gluing device; and wherein:
the control system causes the gluing station to not apply glue to flaps of a specific carton of cigarettes if the data generated by the optical scanner for tax indicia of a specific carton of cigarettes does not satisfy the predefined criteria.

10. The apparatus of claim 7, wherein:
the predefined criteria include tax stamp data received by the control system, and wherein the data generated by the optical scanner is compared to tax data received by the control system.

11. The apparatus of claim 10, wherein:
the control system generates a signal if the data generated by the optical scanner for a selected package of cigarettes is significantly different than the tax data received by the control system for the selected package of cigarettes.

12. The apparatus of claim 4, wherein:
the apparatus is operably connected to a remote tax authority, and wherein information relating to the data generated by the optical scanner is transferred to the remote tax authority.

13. The apparatus of claim 12, wherein:
the remote tax authority generates a control signal that is received by the control system of the apparatus whereby the remote tax authority has at least some control over the operation of the apparatus.

14. The apparatus of claim 13, wherein:
the remote tax authority receives information pertaining to the data generated by the optical scanner.

15. The apparatus of claim 4, wherein:
the control system includes an operating mode that causes the conveyor system to move cartons of cigarettes through the label-applying station without stopping unless predefined operating criteria are present.

16. The apparatus of claim 4, wherein:
the apparatus includes a scanner configured to read bar code information on cartons of cigarettes processed by the apparatus, and wherein the bar code includes information concerning the identity of manufacturers of cartons of cigarettes.

17. The apparatus of claim 16, wherein:
the apparatus is operably connected to a remote tax authority, and information concerning the identity of manufacturers of cartons of cigarettes is supplied to the remote tax authority.

18. The apparatus of claim 17, wherein:
the remote tax authority is operably connected to the control system, and wherein the remote tax authority is capable of generating a control signal to the control system to control at least some aspects of the operation of the apparatus.

19. The apparatus of claim 16, wherein:
the scanner is operably connected to the control system, and wherein the control system receives order information including the identity of manufacturers of cigarettes in the order, and wherein the control system compares information from the scanner to the order information.

20. The apparatus of claim 19, wherein:
the control system alters control of the apparatus if information from the scanner does not match the order information.

21. The apparatus of claim 1, including;
a second elongated belt and a second guide member supporting the second elongated belt.

22. The apparatus of claim 1, wherein:
the guide member includes an elongated channel, and at least a portion of the linear portion of the belt is disposed in the elongated channel.

23. The apparatus of claim 22, wherein:
the elongated belt includes inner and outer surfaces and opposite side edges;
the elongated channel includes a planar vertical surface slidably contacting the outer surface of the elongated belt, and an upwardly facing surface slidably contacting a selected one of the opposite side edges of the elongated belt.

24. The apparatus of claim 23, wherein:
the guide member comprises an elongated linear member extending through the label-applying station and the information-applying station.

25. The apparatus of claim 24, wherein:
the guide member comprises a polymer material.

26. An apparatus for applying tax indicia to packages of cigarettes of the type having generally vertical opposite side faces, the apparatus comprising:
a support structure;
a control system configured to receive tax stamp data;
a powered conveyor system operably connected to the control system, wherein the conveyor system is mounted to the support structure for moving cartons of cigarettes along a path defining a downstream direction;
a loading system configured to receive cartons of cigarettes to be moved along the conveyor system;
an opening station downstream of the loading station, the opening station having an opening member shaped to open flaps of cartons of cigarettes moving along the conveyor system to provide access to packages of cigarettes in the cartons;
a label-applying station downstream of the opening station, the label-applying station including an applicator that applies labels to packages of cigarettes;
an information-applying device operably connected to the control system for applying tax information to packages of cigarettes corresponding to the tax data; and wherein:
at least one support surface substantially preventing rotational movement of cartons of cigarettes about an axis that is parallel to the downstream direction as the tax information is applied to packages of cigarettes.

27. The apparatus of claim 26, wherein:
the device comprises a printer that prints tax indicia on packages of cigarettes.

28. The apparatus of claim 27, wherein:
the printer applies ink to packages of cigarettes.

29. The apparatus of claim 27, wherein:
the printer is located downstream of the label-applying station at a printing station.

30. The apparatus of claim 29, including:
an optical scanner mounted to the support structure downstream of the printing station, wherein the optical scanner reads the tax indicia printed on labels by the printing station and generates data corresponding to the tax indicia; and wherein:
the data generated by the optical scanner is evaluated according to predefined criteria to determine if the predefined criterion is satisfied.

31. The apparatus of claim 30, wherein:
the conveyor system includes at least one elongated belt forming a loop with at least one substantially linear portion, the conveyor system further including at least one guide member supporting the linear portion of the elongated belt, wherein the substantially linear portion of the belt includes a substantially flat side face that contacts vertical side faces of packages of cigarettes as the packages of cigarettes move through the printing station.

32. The apparatus of claim 31, wherein:
the control system stops movement of the one elongated belt if the data generated by the optical scanner does not satisfy predefined criteria.

33. The apparatus of claim 32, including;
a second elongated belt and a second guide member supporting the second elongated belt.

34. The apparatus of claim 31, wherein:
the guide member includes an elongated channel, and at least a portion of the linear portion of the belt is disposed in the elongated channel.

35. The apparatus of claim 34, wherein:
the elongated belt includes inner and outer surfaces and opposite side edges;
the elongated channel includes a planar vertical surface slidably contacting the outer surface of the elongated belt, and an upwardly facing surface slidably contacting a selected one of the opposite side edges of the elongated belt.

36. The apparatus of claim 35, wherein:
the guide member comprises an elongated linear member extending through the label-applying station and the printing station.

37. The apparatus of claim 29, wherein:
the tax indicia printed on the labels comprises two-dimensional bar codes.

38. A method of applying tax indicia to packages of cigarettes of the type having substantially vertical opposite side faces, the method comprising:
generating cigarette tax information;
supplying cigarette tax information to an apparatus configured to apply the tax information to packages of cigarettes;
moving packages of cigarettes through the apparatus along a conveyor in a first direction;
providing the apparatus with a pair of supports;
applying tax information to the packages of cigarettes while the opposite side faces of the packages of cigarettes are in contact with the supports in a manner that substantially prevents movement of the packages of cigarettes except in the first direction;
scanning the tax information to generate scanned tax information.

39. The method of claim 38, wherein:
the tax information is applied to the packages of cigarettes by printing.

40. The method of claim 39, including:
applying labels to packages of cigarettes; and
printing the tax information on the labels.

41. The method of claim 40, wherein:
the labels are applied to packages of cigarettes before the tax information is printed on the labels.

42. The method of claim 41, including:
comparing the scanned tax information to the cigarette tax information supplied to the apparatus.

43. The method of claim 42, including:
generating a signal if the scanned tax information is sufficiently different from the cigarette tax information supplied to the apparatus such that the differences do not meet predefined criteria.

44. An apparatus for applying tax stamp information to packages of cigarettes of the type having opposite side faces, the apparatus comprising:
a conveyor system including a pair of belts having substantially planar surface portions configured to engage opposite side faces of packages of cigarettes;
an opening station positioned adjacent the conveyor system for opening cartons of cigarettes to provide access to individual packages of cigarettes in the cartons;
a device configured to apply tax information to packages of cigarettes after the cartons of cigarettes are opened at the opening station;
a scanner configured to read bar codes on the cartons of cigarettes to generate detected information concerning an identity of a manufacturer of cartons of cigarettes; and
a control system configured to receive order information concerning an identity of a manufacturer of cigarettes in the order information, and wherein the control system compares the order information to the detected information and generates a signal if identities of the manufacturers in the order information does not match the identities of the manufacturers of the detected information.

45. The apparatus of claim 44, wherein:
the apparatus is operably connected to a tax authority that is remote from the apparatus, and wherein at least some of the detected information is transferred to the remote tax authority.

46. The apparatus of claim 44, wherein:
the tax stamp information includes the jurisdiction of a tax authority; and
the control system associates the detected information with the jurisdiction for cartons of cigarettes and thereby generates data that can be utilized to determine how many cartons of cigarettes manufactured by a selected manufacturer have been processed by the apparatus.
